(19) United States
(12) Patent Application Publication
(10) Pub. No.: US 2018/0375250 A1
(43) Pub. Date: Dec. 27, 2018

(54) SHELF SYSTEM HAVING ELECTRICAL SUPPLY

(71) Applicants: Wanjiong Lin, NINGBO (CN); Self Electronics Co., Ltd., NINGBO (CN); Self electronics USA Corporation, Norcross, GA (US)

(72) Inventors: Chengke Zhang, NINGBO (CN); Zhaoyong Zheng, Ningbo (CN)

(73) Assignees: Wanjiong Lin; Self Electronics Co., Ltd.; Self electronics USA Corp.

(21) Appl. No.: 16/008,813

(22) Filed: Jun. 14, 2018

(30) Foreign Application Priority Data
Jun. 22, 2017 (CN) 201710473316.6

(51) Int. Cl. H01R 13/52; A47B 96/02; H01R 4/64

(52) U.S. Cl. CPC H01R 13/5202; A47B 96/021; A47B 2220/0091; H01R 4/64; H01R 13/521

(57) ABSTRACT

A shelf system having electrical supply, comprises at least one backboard, and at least one pick power mechanism. Each pick power mechanism comprises a socket, and a plug. The backboard has a through hole. The socket comprises an inserting cylinder inserted in the through hole, and a clamping portion. The clamping portion comprises a connecting cylinder, a flange disposed on the connecting cylinder, and a wedge buckle disposed on the connecting cylinder and spaced from the flange. The backboard is sandwiched between the wedge buckle and the flange. The plug comprises a cylindrical portion inserted in the connecting cylinder. The shelf system having electrical supply provided by the invention has the plug and the socket so that the plug can be arranged on the backboard and the socket can be inserted on the plug. When assembling the shelf, whatever the shelf system needs to be installed or not, the shelf system is not taken into account. Even if the shelf has been installed, it is also possible to quickly install the pick power mechanism into the shelf, thereby avoiding the waste of manpower and time.

### CROSS-REFERENCE TO A RELATED APPLICATION

This application claims priority to a Chinese Patent Application No. CN 201710473316.6, filed on Jun. 22, 2017.

### FIELD OF THE TECHNOLOGY

The present invention relates to the shelf equipment, with particular emphasis on a shelf system having electrical supply.

### BACKGROUND

The shelf system is widely used, such as in shopping malls, logistics warehouses, factory warehouses and so on, and is provided to place some goods or display some items. In the use of the process, the lighting is necessary in the shelf system, especially in the use of the shelves in the store, the lighting requirements are particularly high, such as saving space, security, easy assembly, beauty, and so on.

In the prior art, the wires of the shelf system having electrical supply generally first passes through the hollow shelf rail of the shelf system, and extends out from the shelf rail. However, when the entire shelf system has been assembled and placed in the mall or supermarket, if users want to set the electrical supply, it will be very troublesome as it is difficult to disassemble the entire shelf and need to arrange the wires. As a result, it costs plurality of manpower and wastes time.

### SUMMARY OF THE INVENTION

Therefore, it is necessary to provide a shelf system having electrical supply that can accomplish to pick the power without dismantling the entire assembled shelf to meet the above demand.

A shelf system having electrical supply, comprising: at least one backboard, and at least one pick power mechanism; each pick power mechanism comprising a socket disposed on the backboard, and a plug inserted in the socket and electrically connected to the socket, the backboard having a through hole for inserting the socket, the socket comprising an inserting cylinder inserted in the through hole and a clamping portion provided at the open end of the inserting cylinder; the clamping portion comprises a connecting cylinder, a flange disposed on the connecting cylinder, and a wedge buckle disposed on the connecting cylinder and spaced from the flange, the backboard being sandwiched between the wedge buckle and the flange; the plug comprising a cylindrical portion inserted in the connecting cylinder.

Further, the socket further comprises an in-line type DC plug provided in the inserting cylinder, and the plug further comprises an in-line type DC socket provided on the cylindrical portion.

Further, an inner diameter of the connecting cylinder corresponds to an outer diameter of the inserting cylinder, and an outer diameter of the connecting cylinder corresponds to a diameter of the through hole.

Further, in a cross section along the axial direction of the inserting cylinder, the radius of the hypotenuse of the wedge buckle gradually increases toward to direction of the flange.

Further, a sealing ring is further disposed on the side wall of the cylindrical portion along the axial direction of the inserting cylinder, and the sealing ring is sandwiched between the cylindrical portion and the connecting cylinder.

Further, a groove is formed on the side wall of the cylindrical portion along the axial direction of the inserting cylinder, and the groove is configured to set the sealing ring.

Further, the entrance diameter of the inner wall of the connecting cylinder is equal to the outer diameter of the sealing ring, and the entrance diameter of the inner wall located close to the inserting cylinder is smaller than the maximum diameter of the sealing ring.

Further, the socket further comprises a buckle plug connected to the flange, and the buckle plug is stuffed in the connector cylinder.

Further, the plug further comprises a base for positioning the cylindrical portion, and a pull ring disposed on the base, and the diameter of the base corresponds to the maximum diameter of the flange.

Further, each pick power mechanism further comprises a receiving tray, the receiving tray is embedded in the backboard, the socket is received in the receiving tray; and the plug further comprises a base for positioning the cylindrical portion, thickness of the base along the axial direction of the inserting cylinder corresponds to the depth of the receiving tray.

Compared with the prior art, the shelf system having electrical supply provided by the invention has the plug and the socket so that the plug can be arranged on the backboard and the socket can be inserted on the plug. When assembling the shelf, whatever the shelf system needs to be installed or not, the shelf system is not taken into account. Even if the shelf has been installed, it is also possible to quickly install the pick power mechanism into the shelf, thereby avoiding the waste of manpower and time.

### DETAILED DESCRIPTION OF THE DRAWINGS

The drawings described herein are intended to promote a further understanding of the present invention, as follows:

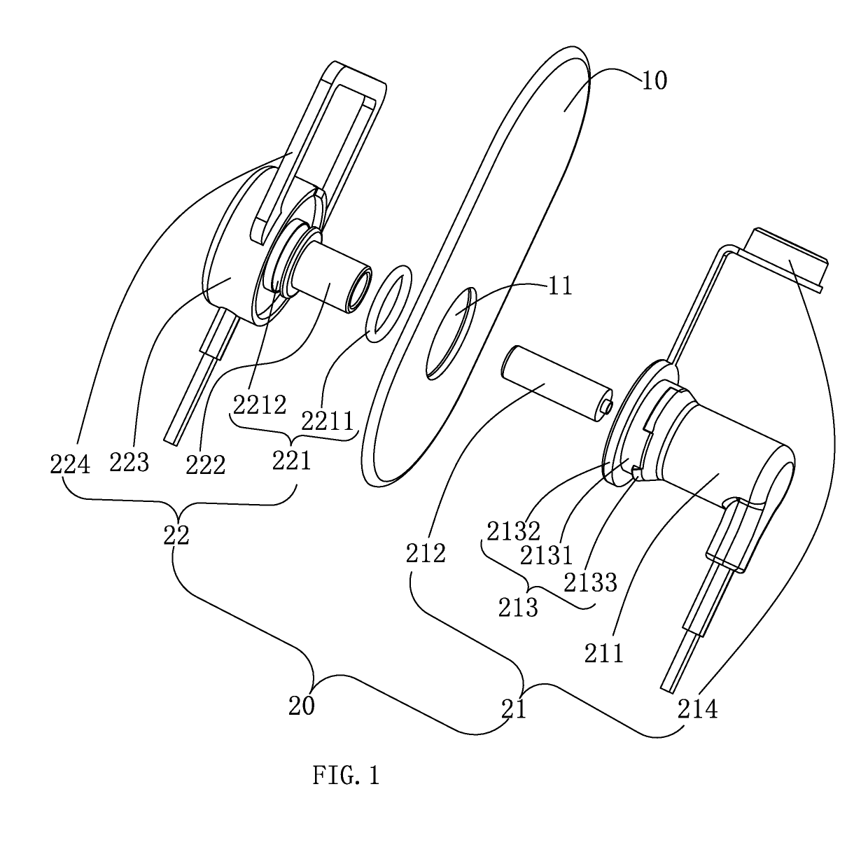

FIG. 1 is an exploded structure diagram of a shelf system having electrical supply according to a first embodiment of the present invention.

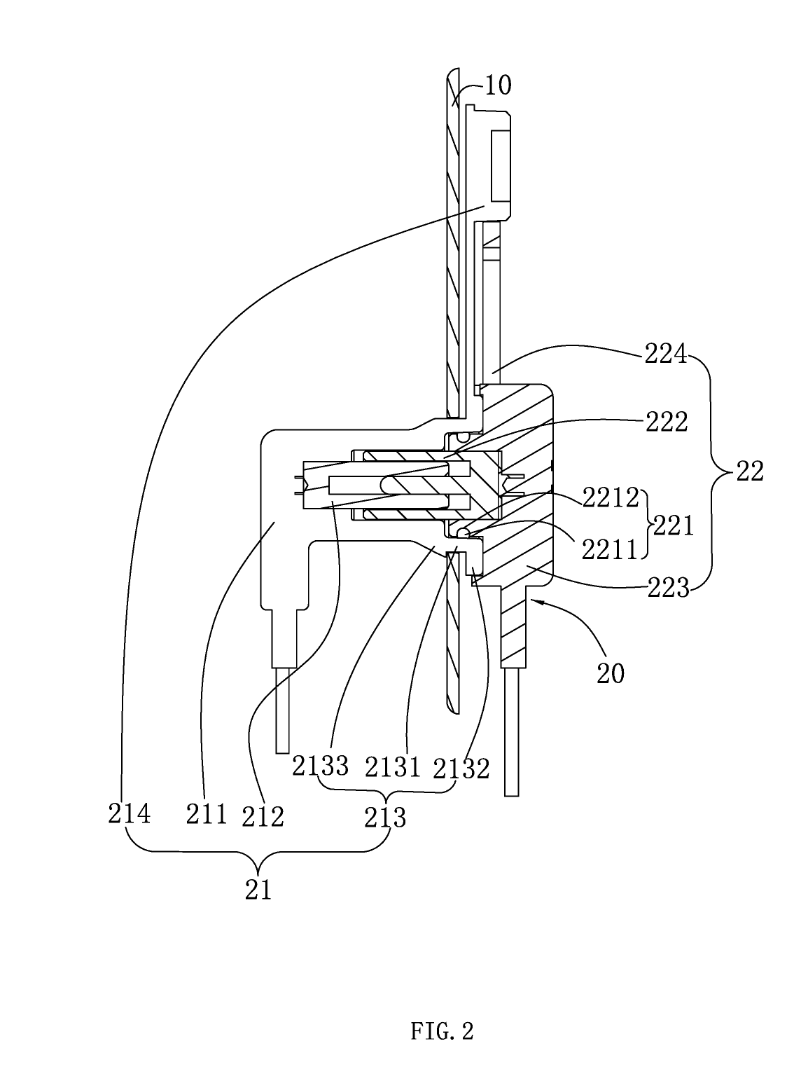

FIG. 2 is a cross-sectional structure diagram of the shelf system having electrical supply of FIG. 1.

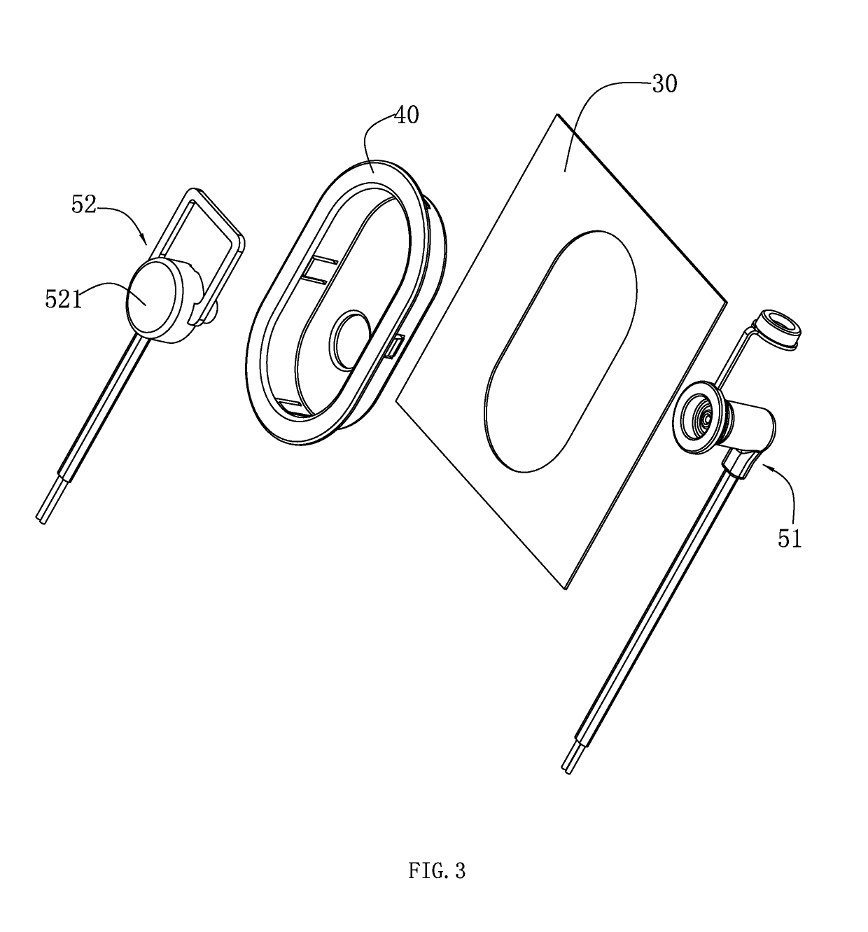

FIG. 3 is an exploded structure diagram of a shelf system having electrical supply according to a second embodiment of the present invention.

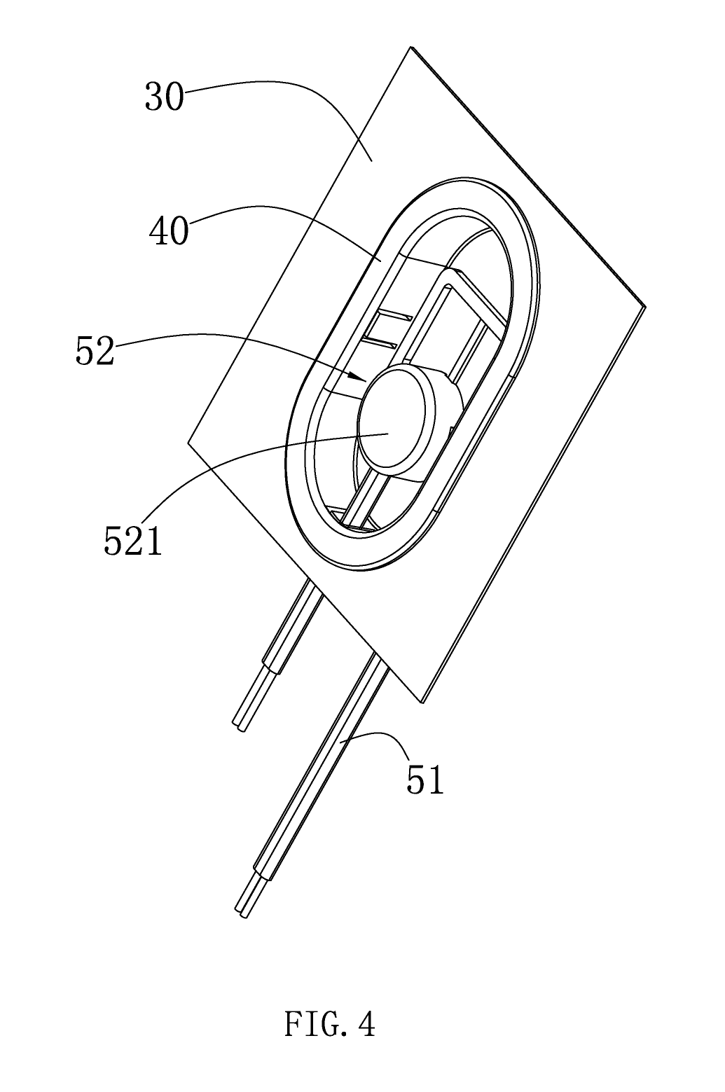

FIG. 4 is an assembly structure diagram of the shelf system having electrical supply of FIG. 3

### DESCRIPTION OF THE PREFERRED EMBODIMENTS

The present application is illustrated by way of the following detailed description based on of the accompanying drawings. It should be noted that illustration to the embodiment in this application is not intended to limit the invention.

Please referring to FIG. 1 and FIG. 2, which is a structure diagram of a shelf system 100 having electrical supply according to the present invention. The shelf system 100 having electrical supply comprises at least one backboard 10, and at least one pick power mechanism 20 disposed on the backboard. It is envisioned that the shelf system 100 further comprises other basic components such as uprights, booms, shelves and the like, as well as some electrical wires for connecting electric supply to the pick power mechanism 20 and for connecting the pick power mechanism 20 to the lamps. These are known to those skilled in the art, and details are not described herein again.

The backboard 10 is usually a flat plate made of a metal material such as steel, which is inserted on the shelf rail for isolating different shelf space. The structure of the backboard 10 is the same as the structure of the backboard in the existing supermarkets and shopping centers, and details are not described herein again. The backboard 10 comprises at least one through hole 11. The through hole 11 is used to set the power collection device 20. It can be understood that the through hole 11 can be opened according to actual needs, such as the need of actual location. At the same time, the through hole 11 can be opened after the backboard 10 is installed in the shelf, or can be opened before the backboard 10 is installed.

Each pick power mechanism 20 has the same structure and function. Only one pick power mechanism 20 is taken as an example to describe its structure and function. The pick power mechanism 20 comprises a socket 21 disposed on the backboard 10 and a plug 22 inserted into the socket 21 and electrically connected to the socket 21.

The socket 21 comprises an inserting cylinder 211 inserted in the through hole 11, an in-line type DC plug 212 provided in the inserting cylinder 211, and a clamping portion 213 provided at the open end of the inserting cylinder 211. The inserting cylinder 211 is used to hold the in-line type DC plug 212, which may be formed by injection molding. The in-line type DC plug 212 is a standard component and is integrally injection molded with the inserting cylinder 211. The in-line type DC plug 212 will not be described herein again because it is a standard component. The in-line type DC plug 212 is spaced apart from the inner side wall of the inserting cylinder 211 for inserting the plug 22. The clamping portion 213 comprises a connecting cylinder 2131 extending from an open end of the inserting cylinder 211 to the axial direction of the inserting cylinder 211, a flange 2132 disposed on the inserting cylinder 2131, and a wedge buckle 2133 disposed on the connecting cylinder 2131 and spaced from the flange 2132. The connecting cylinder 2131 may also be integrally injection-molded with the inserting cylinder 211, and an inner diameter of the connecting cylinder 2131 corresponds to an outer diameter of the inserting cylinder 211, and an outer diameter of the connecting cylinder 2131 corresponds to a diameter of the through hole 11 so as to form a step between the connecting cylinder 2131 and the inserting cylinder 211. When the connecting cylinder 2131 is inserted into the through hole 11, the flange 2132 and the wedge buckle 2133 are used for clamping the backboard 10, and therefore the maximum diameter of the flange 2132 and the wedge buckle 2133 should be larger than the diameter of the through hole 11. In order to insert the connecting cylinder 2131 in the through hole 11, in a cross section along the axial direction of the inserting cylinder, the radius of the hypotenuse of the wedge buckle 2133 gradually increases toward to direction of the flange 2132. When the inserting cylinder 211 is inserted into the through hole 11, the wedge buckle 2133 and the through hole 11 will undergo deformation in their respective yield limits by the hypotenuse of the wedge buckle 2133, the wedge buckle 2133 can pass through the through hole 11 so that the backboard 11 is sandwiched between the wedge buckle 2133 and the flange 2132. In addition, in order to make it easier to insert the wedge buckle 2133 into the through hole 11, the socket 21 can be made of a soft material, such as rubber. The socket 21 further comprises a buckle plug 214 connected to the flange 2132, and the buckle plug 214 is stuffed in the connector cylinder 2131 for the aesthetic appearance. That is, when the plug 21 is not inserted into the socket 21, the buckle plug 214 is inserted into the connecting cylinder 2131 so that the entire backboard is flat. And the second aim is to prevent the dust or water vapor from entering the inserting cylinder 211 to affect the reliability of the in-line type DC plug 212.

The plug 22 comprises a cylindrical portion 221 inserted in the connecting cylinder 2131, an in-line type DC socket 222 provided in the inserting cylinder 221, a base 223 for positioning the cylindrical portion 223, and a pull ring 224 disposed on the base 223. The cylindrical portion 221 is inserted in the connecting cylinder 211. In order to achieve the purpose of waterproofing or increasing the waterproof level, a sealing ring 2211 is further disposed on the cylindrical portion 221, and the sealing ring 2211 is sandwiched between the cylindrical portion 221 and the connecting cylinder 2131. In order to fix the sealing ring 2211, a groove 2212 is formed on the side wall of the cylindrical portion 221 along the axial direction of the inserting cylinder 211, and the groove 2212 is configured to set the sealing ring 2211. In order to increase the tightness, the entrance diameter of the inner wall of the connecting cylinder 2131 is equal to the outer diameter of the sealing ring 2211, and the entrance diameter of the inner wall located close to the inserting cylinder 2131 is smaller than the maximum diameter of the sealing ring 2211. The cylindrical portion 221 facilitates the insertion of the connecting cylinder 2131 and improves the waterproofing level. The in-line type DC socket 222 is also a standard component and the in-line type DC socket 222 and the plug-in type DC plug 212 are a set of mating components, and they should be well known to those skilled in the art and will not be described in detail herein. The in-line type DC socket 222 is disposed coaxially with the cylindrical portion 221. The base 223 is disposed on the cylindrical portion 221 opposite to the in-line type DC socket 222 and the function is to protect the connection wires of the in-line type DC socket 222 while facilitating installation. The diameter of the base 223 corresponds to the diameter of the flange 2132, so as to facilitate the appearance. The pull ring 224 is disposed on the base 223 for pulling the socket 22 from the plug when the socket 22 is inserted into the plug 21 for easy disassembly.

Please referring to FIG. 3 and FIG. 4, which is an exploded structure diagram of a shelf system having electrical supply according to a second embodiment of the present invention. The shelf system further comprises at least one backboard 30, a receiving tray 40 embedded in the backboard 30, and at least one pick power mechanism 50 disposed on the receiving tray 40. The difference between the second embodiment and the first embodiment lies in that the second embodiment is that the second embodiment adds the receiving tray 40, the pick power mechanism 50 is completely the same as the pick power mechanism 20 of the first embodiment, ie, comprises the plug 51 and socket 52.

In the first embodiment, the flange 2132 and the base 223 protrude from the backboard 10, the appearance is affected. In order to make the backboard 30 flat and beautiful, the receiving tray 40 is provided in the second embodiment. The receiving tray 40 is embedded in the backboard 10, and the plug 51 is received in the receiving tray 40. The receiving method is the same as the first embodiment. The socket 52 is inserted into the plug 51 and electrically connected to the plug 51. The socket 52 comprises a base 521. The depth of the base 521 corresponds to that of the receiving tray 40, so that the side of the backboard 30 facing the customer can be flat, which is good for appearance.

Compared with the prior art, the shelf system 100 having electrical supply provided by the invention has the plug 21 and the socket 22 so that the plug 21 can be arranged on the backboard 10 and the socket 22 can be inserted on the plug 21. When assembling the shelf, whatever the shelf system needs to be installed or not, the shelf system is not taken into account. Even if the shelf has been installed, it is also possible to quickly install the pick power mechanism 20 into the shelf, thereby avoiding the waste of manpower and time.

The above disclosure has been described by way of example and in terms of exemplary embodiment, and it is to be understood that the disclosure is not limited thereto. Rather, any modifications, equivalent alternatives or improvement etc. within the spirit of the invention are encompassed within the scope of the invention as set forth in the appended claims.

1. A shelf system having electrical supply, comprising: at least one backboard, and at least one pick power mechanism; each pick power mechanism comprising a socket disposed on the backboard, and a plug inserted in the socket and electrically connected to the socket, the backboard having a through hole for inserting the socket, the socket comprising an inserting cylinder inserted in the through hole and a clamping portion provided at the open end of the inserting cylinder; the clamping portion comprises a connecting cylinder, a flange disposed on the connecting cylinder, and a wedge buckle disposed on the connecting cylinder and spaced from the flange, the backboard being sandwiched between the wedge buckle and the flange; the plug comprising a cylindrical portion inserted in the connecting cylinder.

2. The shelf system as claimed in claim 1, wherein the socket further comprises an in-line type DC plug provided in the inserting cylinder, and the plug further comprises an in-line type DC socket provided on the cylindrical portion.

3. The shelf system as claimed in claim 1, wherein an inner diameter of the connecting cylinder corresponds to an outer diameter of the inserting cylinder, and an outer diameter of the connecting cylinder corresponds to a diameter of the through hole.

4. The shelf system as claimed in claim 1, wherein in a cross section along the axial direction of the inserting cylinder, the radius of the hypotenuse of the wedge buckle gradually increases toward to direction of the flange.

5. The shelf system as claimed in claim 1, wherein a sealing ring is further disposed on the side wall of the cylindrical portion along the axial direction of the inserting cylinder, and the sealing ring is sandwiched between the cylindrical portion and the connecting cylinder.

6. The shelf system as claimed in claim 5, wherein a groove is formed on the side wall of the cylindrical portion along the axial direction of the inserting cylinder, and the groove is configured to set the sealing ring.

7. The shelf system as claimed in claim 5, wherein the entrance diameter of the inner wall of the connecting cylinder is equal to the outer diameter of the sealing ring, and the entrance diameter of the inner wall located close to the inserting cylinder is smaller than the maximum diameter of the sealing ring.

8. The shelf system as claimed in claim 1, wherein the socket further comprises a buckle plug connected to the flange, and the buckle plug is stuffed in the connector cylinder.

9. The shelf system as claimed in claim 1, wherein the plug further comprises a base for positioning the cylindrical portion, and a pull ring disposed on the base, and the diameter of the base corresponds to the maximum diameter of the flange.

10. The shelf system as claimed in claim 1, wherein each pick power mechanism further comprises a receiving tray, the receiving tray is embedded in the backboard, the socket is received in the receiving tray; and the plug further comprises a base for positioning the cylindrical portion, thickness of the base along the axial direction of the inserting cylinder corresponds to the depth of the receiving tray.
